(19) United States
(12) Patent Application Publication
(10) Pub. No.: US 2026/0192538 A1
(43) Pub. Date: Jul. 9, 2026

(54) PART COMPRISING A MONOLITHIC ARCHITECTURAL LATTICE STRUCTURE

(71) Applicant: COMMISSARIAT A L'ENERGIE ATOMIQUE ET AUX ENERGIES ALTERNATIVES, Paris (FR)

(72) Inventors: Michaël BOUVIER, Grenoble Cedex 09 (FR); Hervé GLEYZES, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/131,739

(22) PCT Filed: Nov. 21, 2023
(86) PCT No.: PCT/EP2023/082614

§ 371 Date: May 21, 2025

(30) Foreign Application Priority Data
Nov. 22, 2022 (FR) FR2212166

(51) Int. Cl. B32B 3/12; B32B 15/01; B32B 25/04; B33Y 80/00

(52) U.S. Cl. CPC B32B 3/12; B33Y 80/00; B32B 15/01; B32B 25/042; B32B 2250/02; B32B 2307/56

(57) ABSTRACT

A part including a monolithic structure includes: a body mesh including a plurality of elementary body patterns periodically repeated and in contact with one another, each elementary body pattern being of the rhombic dodecahedral type; and a skin mesh including a plurality of elementary skin patterns periodically repeated and in contact with one another, each elementary skin pattern including skin beams interconnected to form the edges of a truncated octahedron and connecting beams connecting the skin beams to at least one portion of the vertices of the elementary skin cell, the skin mesh at least partially covering the body mesh, the elementary body patterns being in contact with the elementary skin patterns.

### TECHNICAL FIELD

The present invention concerns the field of architectural lattice structures in particular for forming a device including a flexible interface, for example a fleece interface. These architectural lattice structures can be intended to absorb an impact and/or to form a body support such as a seat cushion of a seat, a cushion, a mattress, an arm rest, a head rest, a wrist support, a holding handle or a helmet lining.

### PRIOR ART

Monolithic architectural lattice structures have a high open-cell porosity. They are formed of beams, which are generally dense, connected to one another in elementary geometric patterns that are repeated periodically in space. They can have advantageous mechanical properties in compression, in particular being able to withstand large deformations without rupture or being deformed irreversibly. They are therefore suitable for applications in which the ability to store and/or to dissipate energy under compression is important, for example for the design of shock absorbers. They are also suitable for applications in which the sensation of comfort in use is required, for example for the design of body supports such as seat cushions of a seat, cushions, mattresses, arm rests, head rests, wrist supports, holding members, for example handles.

In these applications there are looked for in particular structures having a low modulus of elasticity and/or adapted to absorb and/or to dissipate a large quantity of deformation energy before rupture, also termed densification per unit volume.

The mechanical properties in compression of a monolithic architectural lattice structure depend on the source material constituting it and differ depending on the elementary geometric pattern formed by the beams. The paper by M. Nasim and U. Galvanetto: “Mechanical characterisation of additively manufactured PA12 lattice structures under quasi-static compression”, Materials Today Communications, Volume 29, 2021, 102902, compares the mechanical properties of architectural lattice structures as a function of the elementary pattern of the beams.

Of the various known elementary patterns the rhombic dodecahedral type pattern has a low modulus of elasticity and enables a high densification per unit volume to be obtained.

FIGS. 1A and 1B depict a lattice 1 formed of a plurality of elementary patterns 2 of rhombic dodecahedral type repeated periodically and in contact with one another and FIGS. 2A, 2B and 2C depict an elementary pattern 2 of rhombic dodecahedral type. The elementary pattern 2 comprises twenty-four beams 3 connected to one another so as to form the edges of a rhombic dodecahedron 4. The rhombic dodecahedron 4 comprises six vertices 5 with an acute angle and eight vertices 6 with an obtuse angle. An acute angle vertex 5 is a vertex where four faces of the rhombic dodecahedron 4 meet at an acute angle. An obtuse angle vertex 6 is a vertex at which three faces of the rhombic dodecahedron 4 meet at an obtuse angle. The elementary pattern 2 is inscribed in an elementary cell 8 that corresponds to the circumscribed rectangular parallelepiped at each of the acute angle vertices 5. The elementary pattern 2 also includes eight connecting beams 7 each connecting one of the obtuse angle vertices 6 to the nearest vertex of the elementary cell 8. The connecting beams 7 extend along the diagonals of the elementary cell 8.

The rhombic dodecahedral type elementary pattern 2 is similar to the “fluorite” pattern in the “nTopology 3.26.3” software developed and marketed by the company nTopology, Inc. Indeed, it is similar to a crystalline structure of fluorite in which the atomic sites are connected to one another by beams.

As depicted in FIGS. 1A and 1B the adjacent rhombic dodecahedral type elementary patterns 2 are fixed to one another by contact between their respective connecting beams 7 and by contact between their respective acute angle vertices.

Although a monolithic architectural lattice structure 1 employing a periodic elementary pattern 2 of rhombic dodecahedral type has good mechanical characteristics, in particular as a substitute for certain polyurethane foams, it nevertheless has a small contact surface 9. The contact surface 9 consists of all of the points of the structure 1 on the surface enveloping an exterior face 22 of said structure 1. In the monolithic architectural lattice structure 1 in FIGS. 1A and 1B the contact surface 9 is defined by the ends 7a of the connecting beams 7 and the acute angle vertices 5 on the exterior face 22 of the structure 1. When a solid object, for example part of a human body, comes into contact with the structure 1 the contact force is therefore distributed over a small contact area. This results in high local stresses at the contact surface 9. When supporting part of a body there is therefore a feeling of discomfort, the free beams and the edges then acting like points.

There is therefore a need for a monolithic architectural lattice structure overcoming these disadvantages.

### STATEMENT OF INVENTION

The invention concerns a part including a monolithic architectural lattice structure including:
a body lattice including a plurality of body elementary patterns repeated periodically and in contact with one another, each body elementary pattern including body beams connected to one another to form the edges of a rhombic dodecahedron and connecting beams connecting the obtuse angle vertices of the rhombic dodecahedron to the vertices of the body elementary cell which is the smallest rectangular parallelepiped circumscribing the rhombic dodecahedron;
a skin lattice including a plurality of skin elementary patterns repeated periodically and in contact with one another, each skin elementary pattern including skin beams connected to one another to form the edges of a truncated octahedron and connecting beams connecting the skin beams to at least some of the vertices of the skin elementary cell, which is a rectangular parallelepiped circumscribing two opposite rhombic faces of the truncated octahedron and the edges of the truncated octahedron contained in a median plane, said rhombic faces being symmetrical to one another with respect to the median plane,
the skin lattice covering the body lattice at least partly, body elementary patterns being in contact with skin elementary patterns.

A “rhombic dodecahedron” is a convex polyhedron with twelve rhombic faces. It comprises six acute angle vertices, eight obtuse angle vertices and twenty-four edges.

A “truncated octahedron” is a convex polyhedron having eight hexagonal faces and six rhombic faces. It comprises twenty-four vertices and thirty-six edges.

An “elementary cell” is the smallest rectangular parallelepiped circumscribing an elementary pattern. An elementary cell is an imaginary geometric construction, that is to say does not consist of a material, unlike the beams.

The part according to the invention therefore has mechanical properties similar to those of a lattice structure formed of a plurality of elementary patterns of rhombic dodecahedral type. It has a low modulus of elasticity. Furthermore, the part has a larger contact surface than the lattice structure described in the prior art. Indeed, the skin lattice advantageously makes it possible to increase the size of the contact surface of the architectural lattice structure without significantly affecting its mechanical properties, which are for the most part determined by the body lattice. The result of this is that the contact stress is lower when supporting a part of the body and the part is therefore more comfortable for the user.

Furthermore, the skin elementary patterns are complementary to the body elementary patterns, that is to say if a compression force is applied to the skin elementary patterns they transmit those forces homogeneously to the body elementary patterns. This results in a good distribution of stress throughout the architectural lattice structure and therefore improved comfort for the user.

The connecting beams preferably extend along diagonals of the skin elementary cell. The diagonals of a rectangular parallelepiped are defined as the straight line segments connecting each of the vertices of the rectangular parallelepiped to the vertex at the greatest distance from it.

Each skin elementary pattern in contact with a body elementary pattern is preferably oriented so that one of the faces of the corresponding skin elementary cell containing one of the rhombic faces of the truncated octahedron coincides with a face of the corresponding body elementary cell. Said face of the skin elementary cell and said face of the body elementary cell preferably share the same vertices. At least one, preferably each, of said skin elementary patterns preferably includes connecting beams connecting the truncated octahedron to each of the vertices of said face of the skin elementary cell.

At least one, preferably each, of the skin elementary patterns defining an exterior face of the architectural lattice structure preferably includes no connecting beams oriented from the truncated octahedron toward the vertices of said exterior face. The contact surface of the architectural lattice structure formed by the skin lattice advantageously includes no or few pointed shapes.

At least one, preferably each, skin elementary pattern defining an exterior face of the porous structure includes only connecting beams in contact with at least one of the adjacent skin elementary patterns and/or one of the adjacent body elementary patterns.

Each of the skin elementary patterns defining an exterior face of the architectural lattice structure is preferably oriented so that the exterior face contains one of the rhombic faces of the truncated octahedron, said rhombic face preferably being one of the faces inscribed in the correspond skin elementary cell.

The volume between the skin beams forming said rhombic face is preferably filled in, preferably with the material forming the skin beams. This advantageously makes it possible to increase the size of the contact surface of the part without significantly modifying its mechanical properties.

The part can include lands, preferably plane lands, carried by the skin beams forming said rhombic face, the lands having a surface larger than or the same size as the rhombic face. The lands therefore increase the size of the contact surface of the part.

The faces of the skin elementary cell each containing a rhombic face of the truncated octahedron are preferably square, preferably with a side length between 5 mm and 50 mm. The rhombic faces of the truncated octahedron inscribed in the skin elementary cell are therefore also square.

The distance between the two faces of the skin elementary cell containing the rhombic faces of the truncated octahedron as measured orthogonally to said faces can be less than the shortest side length of each of said faces of the skin elementary cell, preferably between 5 mm and 30 mm. The truncated octahedron of the skin elementary cell therefore has a compressed shape. This advantageously makes it possible to limit the volume occupied by the skin lattice compared to the total volume of the architectural lattice structure and therefore to limit its influence on the mechanical properties of the architectural lattice structure.

Alternatively, the distance between the two faces of the skin elementary cell containing the rhombic faces of the truncated octahedron as measured orthogonally to said faces can be greater than the shortest side length of each of said faces of the skin elementary cell, preferably between 5 mm and 30 mm. The truncated octahedron of the skin elementary cell therefore has an expanded shape. This advantageously makes it possible to reduce the number of strata of skin elementary patterns that the skin lattice includes while preserving the same volume occupied by the skin lattice.

A stratum of skin elementary patterns corresponds to all of the skin elementary patterns in contact with one another and extending in a plane.

The body elementary cell can be cubic, preferably with a side length between 5 mm and 50 mm. In other words, the rhombic dodecahedron of the body elementary pattern is regular. The diameter of the skin beams and the diameter of the connecting beams are preferably each less than the diameter of the body beams and the diameter of the connecting beams. The reduction of the diameter of the skin beams and the connecting beams reduces the modulus of elasticity of the skin lattice and the quantity of energy absorbed by the skin lattice prior to rupture or densification per unit volume. The stiffness of the skin lattice therefore decreases relative to the stiffness of the body lattice, preferably until the stiffness of the skin lattice is less than or equal to, preferably less than, the stiffness of the body lattice.

The diameter of the body beams and the diameter of the connecting beams are preferably equal and/or the diameter of the skin beams and the diameter of the connecting beams are preferably equal.

The diameter of the body beams and/or the diameter of the connecting beams can be between 0.6 mm and 3 mm, preferably between 0.8 mm and 2 mm.

The diameter of the skin beams and/or the diameter of the connecting beams can be between 0.6 mm and 3 mm, preferably between 0.8 mm and 2 mm.

The body beams and/or the connecting beams and/or the skin beams and/or the connecting beams are preferably made of a polymer material or metal or a composite material, for example a thermoplastic, preferably an elastomer thermoplastic, or a polymer charged with glass microballs.

The volume occupied by the body lattice preferably represents at least 50% of the total volume occupied by the architectural lattice structure.

The skin lattice can include fewer than five skin elementary pattern strata.

For example, the skin lattice may include a first skin elementary pattern stratum in contact with the body elementary patterns and all the vertices of their skin elementary cell are connected by connecting beams and a second stratum on top of the first stratum of skin elementary patterns the vertices of the faces of the skin elementary cells of which at the surface of the architectural lattice structure, that is to say defining an exterior face of the architectural lattice structure, are not connected to a connecting beam. Only the vertices of the faces of the skin elementary cells of the second stratum coinciding with the first stratum are therefore connected to a connecting beam. The skin elementary patterns of the first stratum are referred to as simple truncated octahedral type elementary patterns and the skin elementary patterns of the second stratum are referred to as modified truncated octahedral type elementary patterns.

In another example the skin lattice can include only one stratum of skin elementary patterns of modified truncated octahedral type. The vertices of the faces of the skin elementary cells coinciding with body elementary cells are therefore connected to a connecting beam and the vertices of the faces of the surface skin elementary cells, that is to say defining an exterior face of the architectural lattice structure, are not connected to any connecting beam.

The invention also concerns a device including a part according to the invention, the device being chosen from:
a shock absorber,
a support for the body, for example a seat cushion of seat, a cushion, a mattress, an armrest, a headrest, a helmet liner or a wrist support, and
a holding member, for example a holding handle or a steering wheel.

The invention finally has for object a method of producing a part according to the invention, the method including the production of the architectural lattice structure by means of an additive manufacturing technique.

### BRIEF DESCRIPTION OF THE DRAWINGS

Other advantages and features will emerge more clearly on reading the following detailed, non-limiting and illustrative description given with reference to the following figures:

FIG. 1A and FIG. 1B are respectively views in perspective and from above of a lattice including a plurality of periodic elementary patterns of rhombic dodecahedral type;

FIG. 2A, FIG. 2B and FIG. 2C are respectively views in perspective, from above and from the front of a rhombic dodecahedral type elementary pattern;

FIG. 3A and FIG. 3B are respectively views in perspective and from the front of a part including a monolithic architectural lattice structure according to the invention;

FIG. 4A and FIG. 4B are respectively views in perspective and from above of a lattice including a plurality of periodic elementary patterns of simple truncated octahedral type;

FIG. 5A and FIG. 5B are perspective views of a simple truncated octahedral type elementary pattern;

FIG. 5C and FIG. 5D are respectively views from above and from the front of a simple truncated octahedral type elementary pattern;

FIG. 6A and FIG. 6B are respectively views in perspective and from above of a lattice including a plurality of periodic elementary patterns of simple truncated octahedral type and modified truncated octahedral type;

FIG. 7A and FIG. 7B are perspective views of an elementary pattern of modified truncated octahedral type;

FIG. 7C and FIG. 7D are respectively views from above and from in front of an elementary pattern of modified truncated octahedral type;

FIG. 8 is a view from above of a lattice including a plurality of periodic elementary patterns of modified truncated octahedral type, plane lands covering square faces on the surface of said lattice;

FIG. 9 is a photograph of a part including a monolithic architectural lattice structure according to the invention; and

FIG. 10 is a graph representing stress as a function of deformation during compression testing of an architectural lattice structure with periodic elementary patterns of rhombic dodecahedral type and an architectural lattice structure according to the invention.

### DETAILED DESCRIPTION

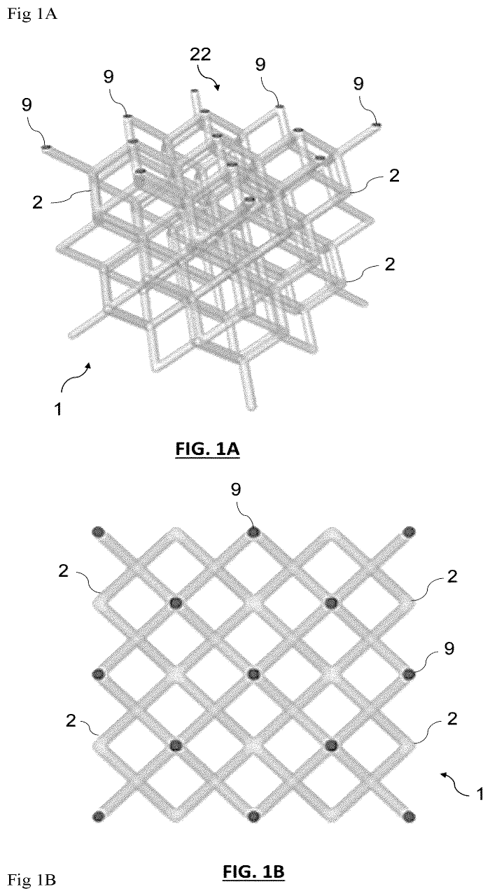

For clarity, references designating the same elements according to the prior art and according to the invention are used in all of FIGS. 1A to 10.

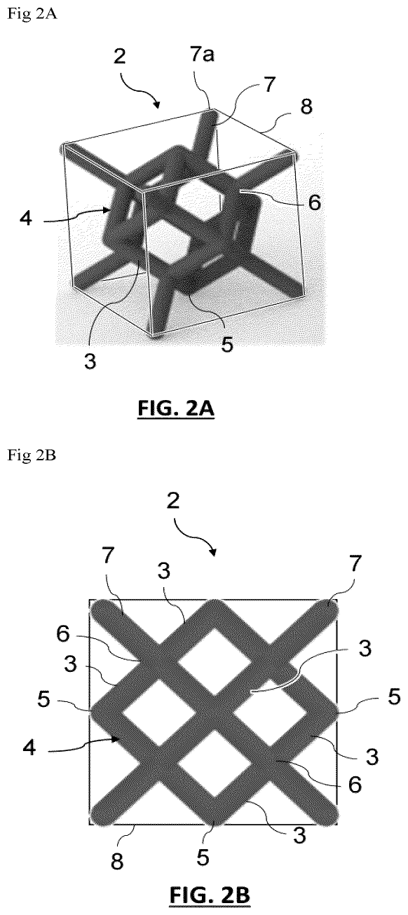

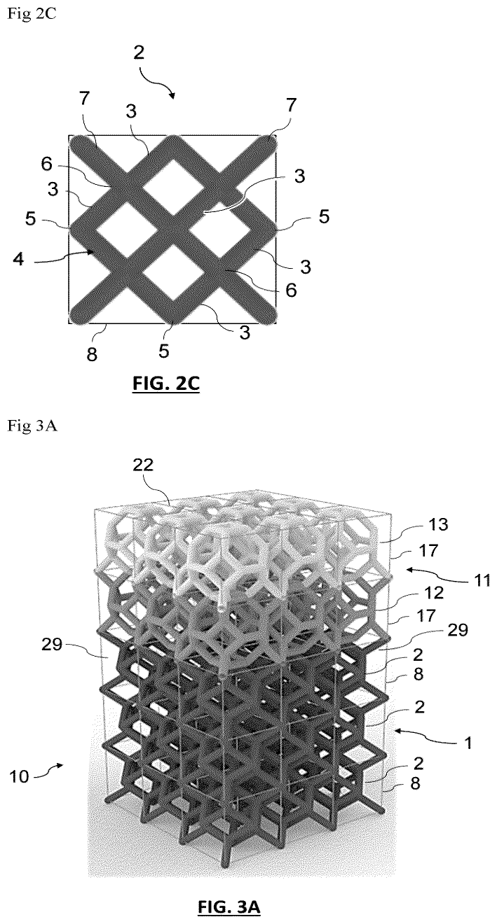

FIGS. 1A to 2C have been described in the above description of the prior art.

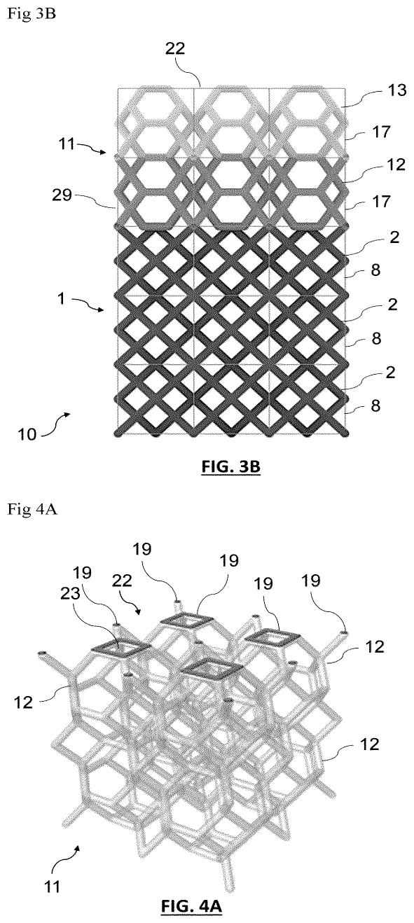

FIGS. 3A and 3B depict a part including an architectural lattice structure 10 according to the invention. The architectural lattice structure 10 is monolithic and includes a body lattice 1 and a skin lattice 11 covering the body lattice 1.

The body lattice 1 is similar to the lattice 1 described in the preamble and depicted in FIGS. 1A and 1B. The body lattice 1 includes a plurality of body elementary patterns 2 repeated periodically in space and in contact with one another. The body elementary patterns 2 are elementary patterns 2 of rhombic dodecahedral type as described above and depicted in FIGS. 2A, 2B and 2C. Thus all the features already described concerning the lattice 1 and the elementary patterns 2 of rhombic dodecahedral type in FIGS. 1A to 2C are applicable to this body lattice 1 and to this body elementary patterns 2.

The skin lattice 11 includes a plurality of skin elementary patterns 12 and 13 repeated periodically in space and in contact with one another. The skin elementary patterns 12 in contact and connected to the body lattice 1 are of simple truncated octahedral type. The skin elementary patterns 13 of the surface of the architectural lattice structure 10, that is to say defining an exterior face 22 of the architectural lattice structure 10, are of modified truncated octahedral type. The skin elementary patterns 13 of modified truncated octahedral type cover the skin elementary patterns 12 of simple truncated octahedral type so that the latter patterns 12 are sandwiched by the first patterns 13 and the body lattice 1.

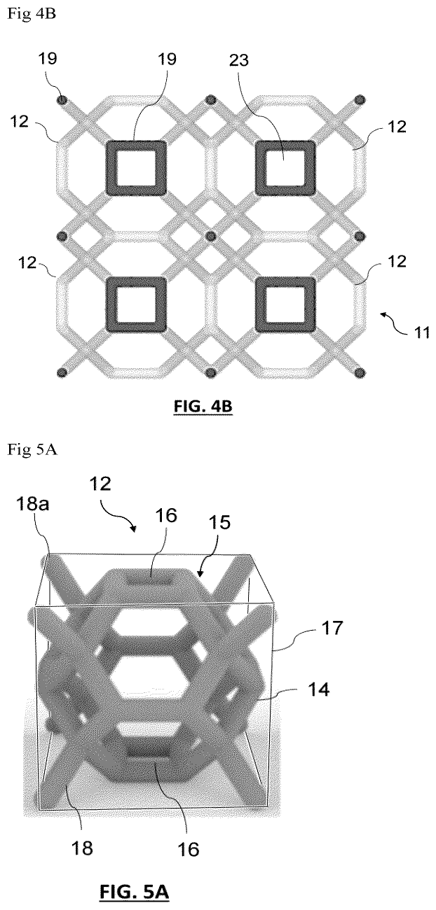

FIGS. 4A and 4B depict a skin lattice 11 including only a plurality of skin elementary patterns 12 of simple truncated octahedral type repeated periodically in space and in contact with one another.

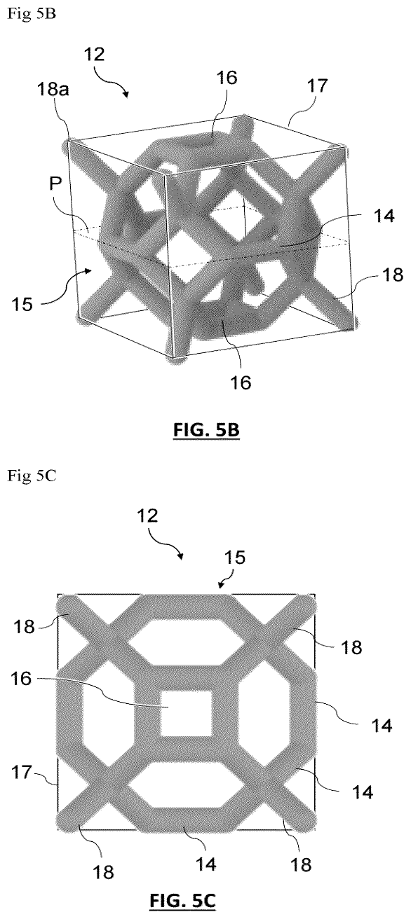

FIGS. 5A to 5D depict a skin elementary pattern 12 of simple truncated octahedral type. Such a skin elementary pattern 12 includes thirty-six skin beams 14 connected to one another so as to form a truncated octahedron 15, the skin beams 14 forming the edges of said truncated octahedron 15. The truncated octahedron 15 includes in particular six rhombic faces 16. The skin elementary pattern 12 is inscribed in a skin elementary cell 17 that corresponds to the rectangular parallelepiped circumscribing two of the opposite rhombic faces 16 and the skin beams 14 in the median plane P of said two rhombic faces 16. The skin elementary pattern 12 also includes eight connecting beams 18 each connecting one of the vertices of the skin elementary cell 17 to the skin beams 14 along the diagonals of the skin elementary cells 17. The connecting beams 18 are therefore connected to vertices of the truncated octahedron 15.

The skin elementary pattern 12 of simple truncated octahedral type is similar to the “truncated octa” pattern of the “nTopology 3.26.3” software from the company nTopology, Inc.

As depicted in FIGS. 4A and 4B the adjacent skin elementary patterns 12 of simple truncated octahedral type are fixed to one another by contact of the ends of their respective connecting beams 18 and by their rhombic faces 16 inscribed in their skin elementary cell 17 that coincide or by their skin beams 14 circumscribing their skin elementary cells 17 that coincide. The rhombic faces 16 or the skin beams 14 that coincide between two adjacent skin elementary patterns 12 of simple truncated octahedral type are shared between these two skin elementary patterns 12, that is to say form part of each of these two skin elementary patterns 12.

The skin lattice 11 has a contact surface 19 which consists of all of the points of the skin lattice 11 on the surface enveloping the exterior face 22.

In the embodiment depicted in FIGS. 4A and 4B the skin elementary patterns at the surface of the skin lattice 11 are skin elementary patterns 12 of simple truncated octahedral type. The contact surface 19 consists of the ends 18a of the connecting beams 18 and the skin beams 14 forming the edges of the rhombic face 16 containing the exterior face 22 of the skin lattice 11. The contact surface 19 of the skin lattice 11 is therefore larger than the contact surface 9 of the body lattice 1. Furthermore, the contact surface 19 of the skin lattice 11 does not consist only of ends of connecting beams. The sensation of comfort for a user resting on an architectural lattice structure 10 including a body lattice 1 and the skin lattice 11 covering the body lattice 1 is therefore improved.

As depicted in FIGS. 3A and 3B the skin elementary patterns 12 of the skin lattice 11 are fixed to the body elementary patterns 2 of the body lattice 1 by contact between the ends of the connecting beams 18 and the ends of the connecting beams 7. The faces of the body elementary cells 8 and the faces of the skin elementary cells 17 coincide with those sharing the same vertices. The body elementary patterns 2 and the skin elementary patterns 12 are therefore aligned with one another and the number of floating beams, that is to say connecting beams 18 or connecting beams 7 one end of which is free, is limited. In particular, it is possible to design an architectural lattice structure 10 with no floating beams or with no floating beams except on the exterior lateral faces 29 of the architectural lattice structure 10, as depicted in FIGS. 3A and 3B.

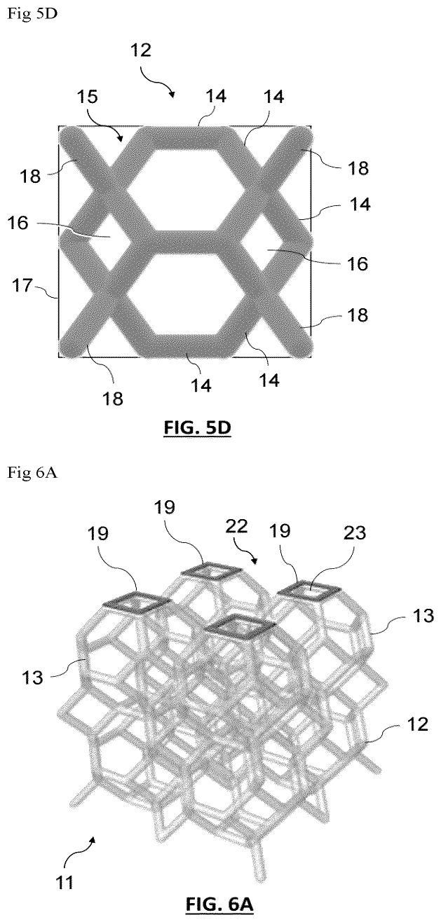

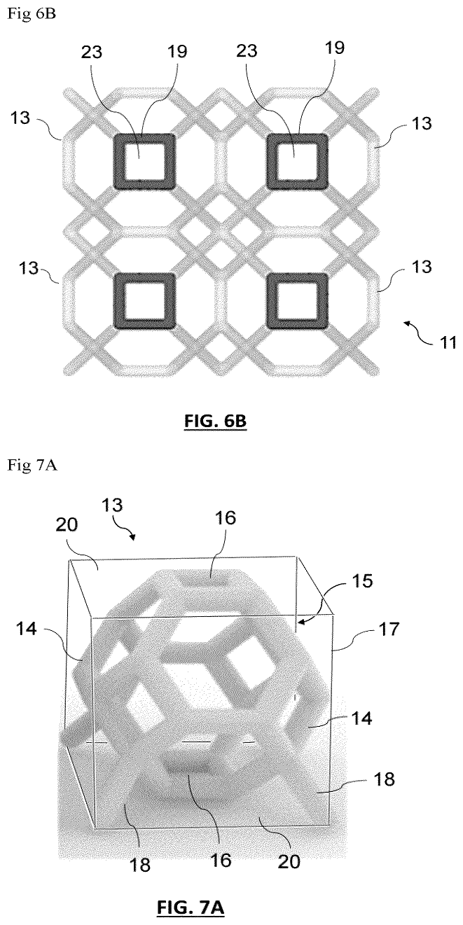

FIGS. 6A and 6B depict a skin lattice 11 similar to the skin lattice 11 depicted in FIGS. 3A and 3B. This skin lattice 11 differs from that depicted in FIGS. 4A and 4B in that it includes a first stratum including a plurality of skin elementary patterns 12 of simple truncated octahedral type repeated periodically along a plane and in contact with one another and a second stratum on top of the first stratum, the second stratum including a plurality of skin elementary patterns 13 of modified truncated octahedral type repeated periodically along the same plane as the skin elementary patterns 12 and in contact with one another. The skin elementary patterns 13 of modified truncated octahedral type are connected to the skin elementary patterns 12 of simple truncated octahedral type.

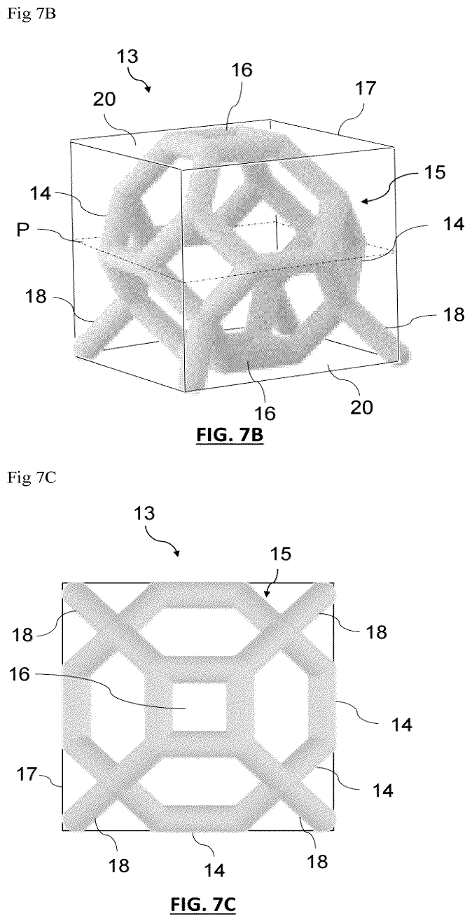

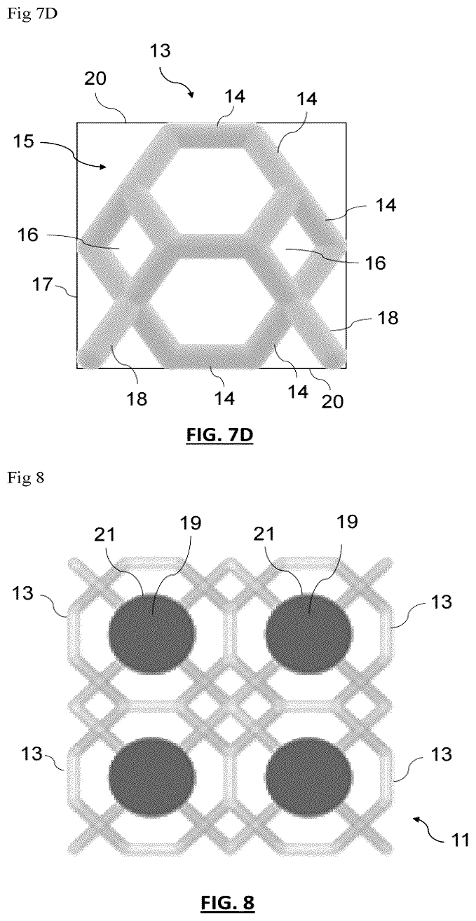

FIGS. 7A to 7D depict a skin elementary pattern 13 of modified truncated octahedral type. Such a skin elementary pattern 13 includes thirty-six skin beams 14 connected to one another so as to form a truncated octahedron 15, the skin beams 14 forming the edges of said truncated octahedron 15. The truncated octahedron 15 includes in particular six rhombic faces 16. The skin elementary pattern 13 is inscribed in a skin elementary cell 17 that corresponds to the rectangular parallelepiped circumscribing two opposite rhombic faces 16 and the skin beams 14 in the median plane P to said two rhombic faces 16. The skin elementary pattern 13 also includes four connecting beams 18, each connecting one of the vertices of the truncated octahedron 15 to one of the vertices of only one of the two faces 20 of the skin elementary cell 17 circumscribing the rhombic faces 16 of the truncated octahedron 15. The vertices of the other of the two faces 20 of the skin elementary cell 17 circumscribing the rhombic faces 16 are not connected to connecting beams 18. The connecting beams 18 follow the diagonals of the skin elementary cell 17. The skin elementary pattern 13 of modified truncated octahedral type is therefore identical to the skin elementary pattern 12 of simple truncated octahedral type except that the connecting beams 18 are fewer in number and do not connect all the vertices of the skin elementary cell 17.

In a similar manner to the skin lattice 11 in FIGS. 4A and 4B and as depicted in FIGS. 6A and 6B the skin elementary patterns 12 of simple truncated octahedral type are fixed to the skin elementary patterns 13 of modified truncated octahedral type by contact between their adjacent connecting beams 18 and their rhombic faces 16 circumscribing their skin elementary cells 17 that coincide. Adjacent skin elementary patterns 13 of modified truncated octahedral type are fixed to one another by contact between their respective connecting beams 18 and by their skin beams 14 circumscribing their skin elementary cells 17 that coincide. The rhombic faces 16 and the skin beams 14 that coincide between two adjacent skin elementary patterns 12 and/or 13 are shared between these two skin elementary patterns 12 and/or 13, that is to say they form part of each of these two skin elementary patterns 12 and/or 13.

As depicted in FIGS. 6A and 6B when the elementary patterns of the skin lattice 11 intended to come into contact with a plane surface are skin elementary patterns 13 of modified truncated octahedral type the contact surface 19 of the skin lattice 11 consists only of skin beams 14 forming the surface rhombic faces 16. In contrast to the skin lattice 11 depicted in FIGS. 4A and 4B there is no connecting beam 18 on the surface of the skin lattice 11 intended to be in contact with a plane surface. The contact surface 19 of the skin lattice 11 in FIGS. 6A and 6B therefore does not include any points. This makes it possible to improve the user's sensation of comfort, relying on an architectural lattice structure 10 including a body lattice 1 and a skin lattice 11 covering the body lattice 1, without significantly decreasing the area of the contact surface 19.

Plane lands 21 can advantageously be carried on the rhombic faces 16 of the skin elementary patterns 13 on the surface of the architectural lattice structure 10. Such an embodiment is illustrated in FIG. 8. These plane lands 21 enable a significant increase in the area of the contact surface 19 of the architectural lattice structure 10 without significantly modifying the mechanical properties of said architectural lattice structure 10. This improves the comfort of such a mechanical structure.

Alternatively, a textile cover, for example made of cloth or leather, for example of Alcantara, can be carried by the rhombic faces 16 of the skin elementary patterns 13 on the surface of the architectural lattice structure 10.

The architectural lattice structure 10 can be manufactured by an additive manufacturing technique, for example on a bed of powder, for example by laser sintering said bed of powder. The powder can be a polymer. If necessary the cover can be mounted on the architectural lattice structure 10 after depowdering the latter. The cover therefore does not impede access to the architectural lattice structure 10 to depowder it.

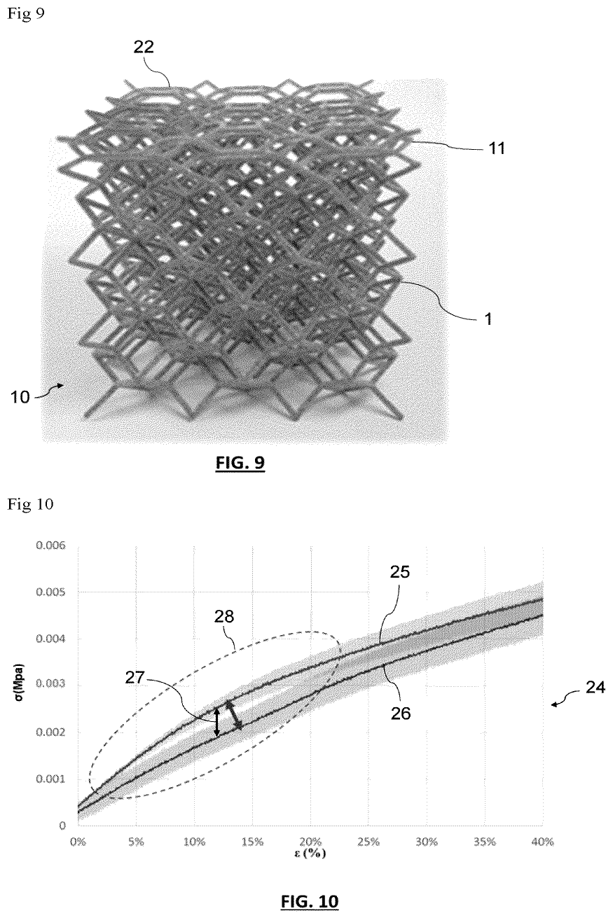

The inventors have manufactured by an additive manufacturing technique a part depicted in FIG. 9 including an architectural lattice structure 10 according to the invention. The architectural lattice structure 10 is monolithic and made of polyurethane thermoplastic (TPU). The architectural lattice structure 10 includes a body lattice 1 and a skin lattice 11 covering the body lattice 1.

The body lattice 1 includes a plurality of body elementary patterns 2 repeated periodically in space and in contact with one another. The body elementary patterns 2 are of rhombic dodecahedral type with their body elementary cell 8 of cubic shape having 20 mm edges and with their body beams 3 and their connecting beams 7 having a diameter equal to 1.1 mm. The skin lattice 11 includes a single stratum including a plurality of skin elementary patterns 12 repeated periodically in a plane and in contact with one another. The skin elementary patterns 12 are of simple truncated octahedral type with their skin elementary cell 17 having a 20 mm square base and a height equal to 7 mm, the bases corresponding to the faces 20 of the skin elementary cell 17 circumscribing the rhombic faces 16 of the truncated octahedron 15 and the height being the distance between these bases. The skin beams 14 and the connecting beams 18 have a diameter equal to 0.8 mm.

The inventors have carried out comparative compression testing of the architectural lattice structure 10 depicted in FIG. 9 and a control architectural lattice structure consisting only of a body lattice 1. The body elementary patterns 2 of the control architectural lattice structure are identical to the body elementary patterns 2 of the body lattice 1 of the architectural lattice structure 10 depicted in FIG. 9. The compression tests were carried out in a direction normal to the plane in which the skin lattice 11 of the architectural lattice structure 10 depicted in FIG. 9 extends.

FIG. 10 shows the results of these comparative tests in the form of a graph 24. The graph 24 includes a stress-deformation curve 25 of the compression test of the control architectural lattice structure and a stress-deformation curve 26 of the compression test of the architectural lattice structure 10 depicted in FIG. 9.

As seen in the graph 24 the structure 10 depicted in FIG. 9 has a Young's modulus lower than the Young's modulus of the control structure. This is indicated in particular by the stress difference 27 at fixed deformation between the curves 25 and 26 in the region 28 of elastic deformation of the structures. The behavior in compression of the structure 10 therefore differs by the presence of the skin lattice 11 compared to the control structure. In particular, for compression deformation less than or equal to 20% the stress difference increases with the deformation. For a deformation greater than 20% it is substantially constant. The presence of a skin lattice 11 on a body lattice 1 of the architectural lattice structure 10 according to the invention therefore improves comfort for a user resting on said structure 10. Other variants and improvements may obviously be envisaged without departing from the scope of the invention as defined by the following claims.

1. A part including a monolithic architectural lattice structure including:
a body lattice including a plurality of body elementary patterns repeated periodically and in contact with one another, each body elementary pattern including body beams connected to one another to form the edges of a rhombic dodecahedron and connecting beams connecting the obtuse angle vertices of the rhombic dodecahedron to the vertices of the body elementary cell which is the smallest rectangular parallelepiped circumscribing the rhombic dodecahedron;
a skin lattice including a plurality of skin elementary patterns repeated periodically and in contact with one another, each skin elementary pattern including skin beams connected to one another to form the edges of a truncated octahedron, and connecting beams connecting the skin beams to at least some of the vertices of the skin elementary cell, which is a rectangular parallelepiped circumscribing two opposite rhombic faces of the truncated octahedron and the edges of the truncated octahedron contained in a median plane, said rhombic faces being symmetrical to one another with respect to the median plane,
the skin lattice covering the body lattice at least partly, body elementary patterns being in contact with skin elementary patterns.

2. The part as claimed in claim 1, the connecting beams extending along diagonals of the skin elementary cell.

3. The part as claimed in claim 1, each skin elementary pattern in contact with a body elementary pattern being oriented so that one of the faces of the corresponding skin elementary cell containing one of the rhombic faces of the truncated octahedron coincides with a face of the corresponding body elementary cell.

4. The part as claimed in claim 3, said face of the skin elementary cell and said face of the body elementary cell sharing the same vertices.

5. The part as claimed in claim 4, wherein at least one, of said skin elementary patterns includes connecting beams connecting the truncated octahedron to each of the vertices of said face of the skin elementary cell.

6. The part as claimed in claim 1, wherein at least one, of the skin elementary patterns defines an exterior face of the architectural lattice structure including no connecting beams oriented from the truncated octahedron toward the vertices of said exterior face.

7. The part as claimed in claim 1, wherein each of the skin elementary patterns defines an exterior face of the architectural lattice structure being oriented so that the exterior face contains one of the rhombic faces of the truncated octahedron, said rhombic face being one of the faces inscribed in the correspond skin elementary cell.

8. The part as claimed in claim 7, the volume between the skin beams forming said rhombic face being filled in, with the material forming the skin beams.

9. The part as claimed in claim 7, further comprising plane lands carried by the skin beams forming said rhombic face, the plane lands having a surface larger than or the same size as the rhombic face.

10. The part as claimed in claim 1, wherein the faces of the skin elementary cell each contains a rhombic face of the truncated octahedron being square.

11. The part as claimed in claim 1, wherein the distance between the two faces of the skin elementary cell containing the rhombic faces of the truncated octahedron as measured orthogonally to said faces is less than the shortest side length of each of said faces.

12. The part as claimed in claim 1, wherein the body elementary cell is cubic, with a side length between 5 mm and 50 mm.

13. The part as claimed in claim 1, wherein the diameter of the skin beams and the diameter of the connecting beams each being less than the diameter of the body beams and the diameter of the connecting beams.

14. The part as claimed in claim 1, wherein the diameter of the body beams and the diameter of the connecting beams being equal and/or the diameter of the skin beams and the diameter of the connecting beams being equal.

15. The part as claimed in claim 1, wherein the diameter of the body beams and/or the diameter of the connecting beams being between 0.6 mm and 3 mm.

16. The part as claimed in claim 1, wherein the diameter of the skin beams and/or the diameter of the connecting beams being between 0.6 mm and 3 mm.

17. The part as claimed in claim 1, wherein the body beams and/or the connecting beams and/or the skin beams and/or the connecting beams being made of a thermoplastic material or of metal.

18. A device including a part as claimed in claim 1, the device being chosen from:
a shock absorber,
a support for the body, for example a seat cushion of seat, a cushion, a mattress, an armrest, a headrest, a helmet liner or a wrist support, and
a holding member, for example a holding handle, or a steering wheel.

19. A method of producing a part as claimed in claim 1, the method including the production of the architectural lattice structure by means of an additive manufacturing technique.
